(19) United States
(12) Patent Application Publication
(10) Pub. No.: US 2018/0141269 A1
(43) Pub. Date: May 24, 2018

(54) 3D PRINTER USING LINEAR LASER SOURCE

(71) Applicant: SINDOH CO., LTD., Seoul (KR)

(72) Inventors: Byoung-bag LEE, Seoul (KR); Min-sung BAN, Seoul (KR); Dong-hee KIM, Seoul (KR)

(21) Appl. No.: 15/816,042

(22) Filed: Nov. 17, 2017

(30) Foreign Application Priority Data
Nov. 21, 2016 (KR) 10-2016-0155185

(51) Int. Cl. B29C 64/153; B33Y 10/00; B33Y 30/00; G05B 19/4099

(52) U.S. Cl. CPC B29C 64/153; B33Y 10/00; G05B 2219/49023; G05B 19/4099; B33Y 30/00

(57) ABSTRACT

The present invention provides a 3D printer using a linear laser source, the 3D printer including: a vat disposed at a lower portion inside a frame and configured to contain liquid photocurable resin therein; a bed configured to be vertically movable in the vat and to support an object; a bed-carrying unit configured to move the bed vertically; a light emission unit configured to cure the liquid photocurable resin in the vat to form the object by radiating a laser beam to the liquid photocurable resin in the vat; a light emission unit-carrying unit configured to move the light emission unit in the longitudinal direction of the vat; and a control unit configured to control operation of the light emission unit, the light emission unit-carrying unit, and the bed-carrying unit, wherein the light emission unit linearly emits a laser beam in the width direction of the vat.

### BACKGROUND OF THE INVENTION

### 1. Field of the Invention

The present invention relates to a 3D printer using a linear laser source, the 3D printer producing a 3D object by radiating a laser beam to liquid photocurable resin.

### 2. Description of the Prior Art

A 3D printer is a manufacturing apparatus that produces an object by continuously outputting layers of a material, like a 2D printer, and stacking the layers. 3D printers can quickly produce an object on the basis of digitized drawing information, so they are generally used to manufacture prototypes.

As for the production method used by 3D printers, there are an SLA (Stereo Lithography Apparatus), which radiates a laser beam to a photocurable material so that the irradiated portion becomes a product, and an SLM (Selective laser melting), that melts and stacks thermoplastic filaments.

Among the production methods employed by 3D printers, a 3D printer using SLA produces a 3D object by curing liquid photocurable resin through radiating a laser beam to a vat containing the liquid photocurable resin.

A light emission unit for emitting a laser beam includes a galvanometer mirror between a laser source and a bed on which a 3D object is produced, and controls the galvanometer mirror along X and Y axes and controls the bed along the Z axis to produce a 3D object.

However, 3D printers of the related art have a drawback in that the size of the light emission unit is increased by the structure of the galvanometer mirror, which is controlled along X and Y axes, and in that the configuration of a control unit is complicated because it is necessary to control the galvanometer mirror and the bed.

### SUMMARY OF THE INVENTION

An object of the present invention is to provide a 3D printer using a linear laser source, the 3D printer controlling a light emission unit in a simple manner and having a simplified configuration.

In accordance with an aspect of the present invention, there is provided a 3D printer using a linear laser source, the 3D printer including: a vat disposed at a lower portion inside a frame and configured to contain liquid photocurable resin therein; a bed configured to be vertically movable in the vat and to support an object; a bed-carrying unit configured to move the bed vertically; a light emission unit configured to cure the liquid photocurable resin in the vat to form the object by radiating a laser beam to the liquid photocurable resin; a light emission unit-carrying unit configured to move the light emission unit in the longitudinal direction of the vat; and a control unit configured to control the operation of the light emission unit, the light emission unit-carrying unit, and the bed-carrying unit, wherein the light emission unit linearly emits a laser beam in the width direction of the vat.

The light emission unit may be configured to include: a light emission unit body fixed to the light emission unit-carrying unit and moved in the longitudinal direction of the vat; a laser diode disposed in the light emission unit body and configured to radiate a laser beam in a predetermined direction; a polygon mirror disposed in the light emission unit body and configured to linearly reflect the laser beam emitted from the laser diode in the width direction of the vat while rotating; and a refractive mirror disposed between the light emission unit body and the vat and configured to refract the laser beam reflected from the polygon mirror to the liquid photocurable resin in the vat.

The polygon mirror may have a rotational axis perpendicular to the surface of the liquid photocurable resin in the vat, and may have a rotational surface parallel to the surface of the liquid photocurable resin.

The light emission unit may further include: a cylindrical lens configured to concentrate the laser beam emitted from the laser diode to reflective surfaces of the polygon mirror; a first F-θ lens disposed between the polygon mirror and the refractive mirror and configured to concentrate laser beams reflected by the reflective surfaces of the polygon mirror toward the vat; and a second F-θ lens disposed between the first F-θ lens and the refractive mirror and configured to concentrate the laser beams reflected by the reflective surfaces of the polygon mirror toward the vat.

The light emission unit may further include: a beam-detecting sensor configured to determine an output start point of image data of the object by receiving the laser beams reflected from the polygon mirror; a beam-detecting mirror configured to reflect the laser beams reflected from the polygon mirror to the beam-detecting sensor; and a beam-detecting lens disposed between the beam-detecting mirror and the beam-detecting sensor and configured to concentrate the laser beams reflected from the beam-detecting mirror.

The laser diode may be composed of a plurality of laser diodes spaced at regular intervals from each other around a point on the polygon mirror, and the plurality of laser diodes may radiate laser beams such that the laser beams are concentrated on the point on the polygon mirror.

The 3D printer may further include a blade unit configured to level the top of the object that is manufactured in the vat by horizontally moving in the longitudinal direction of the vat and to be moved along with the light emission unit by the light emission unit-carrying unit.

According to another aspect of the present invention, there is provided a 3D printer using a linear laser source, the 3D printer including: a vat disposed at a lower portion inside a frame and configured to contain liquid photocurable resin therein; a bed configured to be vertically movable in the vat and to support an object; a bed-carrying unit configured to move the bed vertically; a light emission unit configured to cure the liquid photocurable resin in the vat to form the object by radiating a laser beam to the liquid photocurable resin in the vat; and a control unit configured to control the operation of the light emission unit and the bed-carrying unit, wherein the light emission unit is configured to linearly radiate a laser beam in the width direction of the vat.

The light emission unit may include: a light emission unit body fixed to the frame; a laser diode disposed in the light emission unit body and configured to radiate a laser beam in a predetermined direction; a polygon mirror disposed in the light emission unit body and configured to linearly reflect the laser beam emitted from the laser diode in the width direction of the vat while rotating; and a refractive mirror disposed between the light emission unit body and the vat to be movable parallel to the surface of the liquid photocurable resin in the vat and configured to refract the laser beam reflected from the polygon mirror to the liquid photocurable resin in the vat.

The refractive mirror may include: a first mirror configured to refract vertically downwards a laser beam horizontally emitted from the laser diode; a second mirror disposed under the first mirror and configured to horizontally refract the laser beam refracted by the first mirror toward the light emission unit body; and a third mirror disposed at the same height as the second mirror and configured to refract vertically downwards the laser beam refracted by the second mirror to the liquid photocurable resin in the vat.

The first mirror and the second mirror may be moved together, and the third mirror may be moved at a different speed from the first mirror and the second mirror in order to maintain a constant length of the path of a laser beam from the laser diode to the liquid photocurable resin.

According to the present invention, since the 3D printer has a structure in which a laser beam emitted from the light emission unit is linearly formed and travels horizontally, it is possible to simplify the structure of the apparatus in comparison to the related art, in which a galvanometer mirror is controlled along X and Y axes, and it is also possible to reduce the time taken to manufacture a 3D object by decreasing a laser beam emission time. Further, it is possible to simplify the control unit because only the light emission unit-carrying unit and the bed-carrying unit are controlled.

### BRIEF DESCRIPTION OF THE DRAWINGS

The above and other aspects, features and advantages of the present invention will be more apparent from the following detailed description taken in conjunction with the accompanying drawings, in which:

FIG. 1 is a perspective view showing a 3D printer using a linear laser source according to the present invention;

FIG. 2 is a perspective view, seen from another direction, showing the 3D printer using a linear laser source according to the present invention;

FIG. 3 is a front view showing the 3D printer using a linear laser source according to the present invention;

FIG. 4 is a side view showing the 3D printer using a linear laser source according to the present invention;

FIG. 5 is a perspective view showing a bed and a bed-carrying unit of the 3D printer using a linear laser source according to the present invention;

FIG. 6 is a perspective view showing a light emission unit-carrying unit of the 3D printer using a linear laser source according to the present invention;

FIG. 7 is a perspective view showing a light emission unit of the 3D printer using a linear laser source according to the present invention;

FIG. 8 is a perspective view showing the interior of the light emission unit of the 3D printer using a linear laser source according to the present invention;

FIG. 9 is a plan view showing the light emission unit of the 3D printer using a linear laser source according to the invention, which shows the path of a laser beam;

FIG. 10 is a view showing an example of a laser diode of the 3D printer using a linear laser source according to the present invention;

FIG. 11 is a perspective view showing a blade unit of the 3D printer using a linear laser source according to the present invention; and

FIGS. 12 and 13 are side views schematically showing alternative embodiments of the 3D printer using a linear laser source according to the present invention, which shows the configuration of a movable refractive mirror.

### DETAILED DESCRIPTION OF THE EXEMPLARY EMBODIMENTS

Hereinafter, exemplary embodiments of a 3D printer using a linear laser source according to the present invention are described in detail with reference to the accompanying drawings.

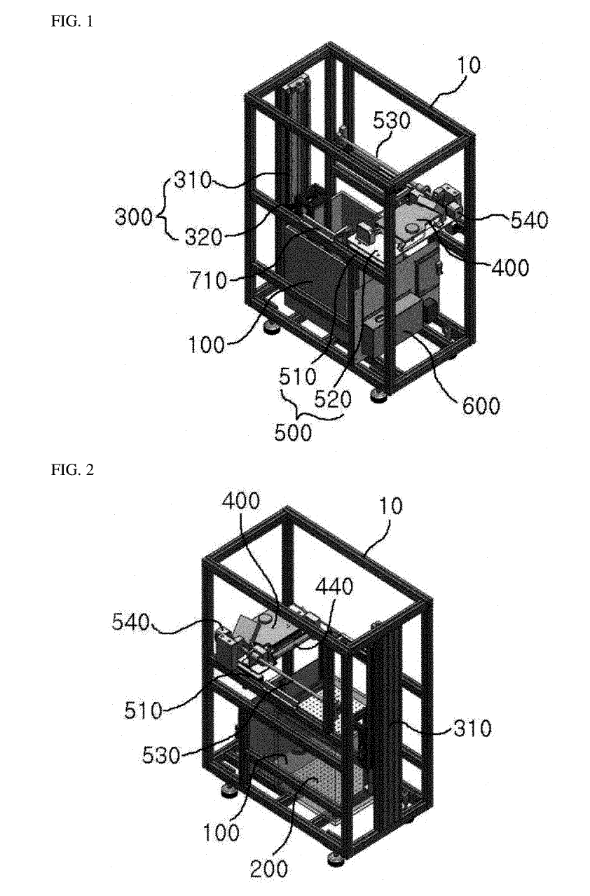

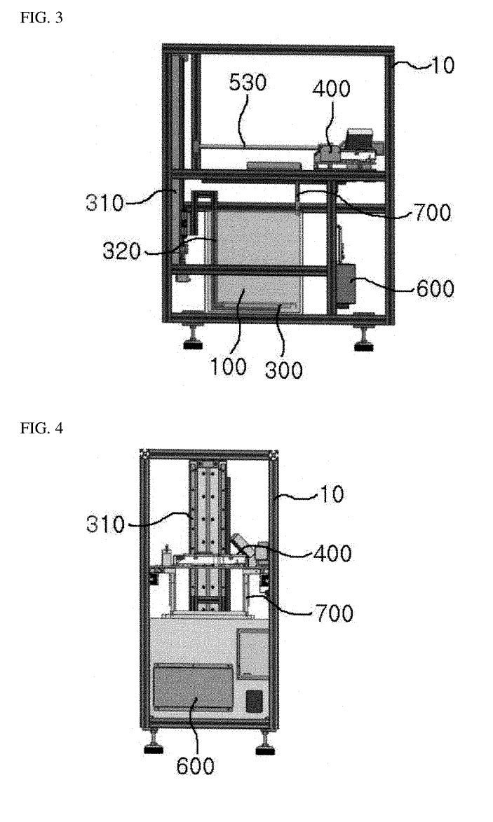

Referring to FIGS. 1 to 4, a 3D printer using a linear laser source according to the present invention includes: a vat 100 that contains liquid photocurable resin; a bed 200 that supports an object in the vat 100; a bed-carrying unit 300 that moves the bed 200; a light emission unit 400 that cures the liquid photocurable resin to form an object by radiating a laser beam to the liquid photocurable resin; a light emission unit-carrying unit 500 that moves the light emission unit 400; and a control unit 600 that controls the operation of the light emission unit 400, the light emission unit-carrying unit 500, and the bed-carrying unit 300.

The vat 100 is disposed at a lower portion inside a hexahedral frame 10 and liquid photocurable resin is stored in the vat 100.

The bed 200 supports an object that is made of the liquid photocurable resin cured by a laser beam, that is, a 3D object. The bed 200 can be vertically moved in the vat 100 by the bed-carrying unit 300 to be described below.

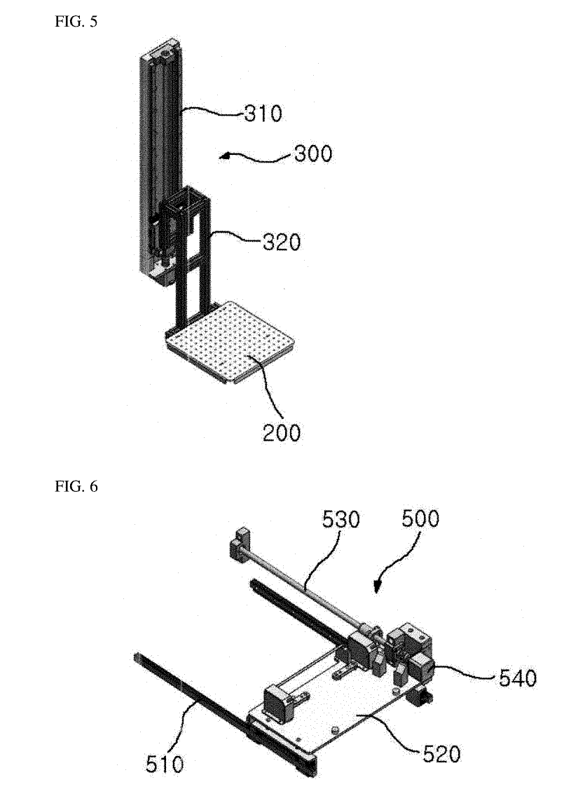

The bed-carrying unit 300 includes a vertical rail 310 and a carrier 320 that can be vertically moved along the vertical rail 310. The vertical rail 310 is vertically disposed on a first side of the frame 10. The carrier 320 has a first end that can vertically move along the vertical rail 310 and a second end that is coupled to the bed 200 to move the bed 200 up and down (see FIG. 5).

The light emission unit 400 cures liquid photocurable resin to form a 3D object by radiating a laser beam to the liquid photocurable resin in the vat 100 on the basis of a predetermined pattern. The light emission unit 400 linearly radiates a laser beam in the width direction of the vat 100 and can be moved in the longitudinal direction of the vat 100 by a light emission unit-carrying unit 500, which will be described below.

The light emission unit-carrying unit 500 includes horizontal rails 510 and a moving plate 520 that can move horizontally along the horizontal rails 510, that is, in the longitudinal direction of the vat 100. The horizontal rails 510 are horizontally disposed along the front and rear sides of the frame 10. The moving plate 520 is disposed between a pair of horizontal rails 510 and is moved along the horizontal rails 510 by a gear motor 540 that is operated along a driving shaft 530. The light emission unit 400 is fixed on the top of the moving plate 520 (see FIG. 6).

The control unit 600 is disposed on a second side of the frame 10 and controls the operation of the light emission unit 400, the light emission unit-carrying unit 500, and the bed-carrying unit 300 on the basis of the date on an inputted object to manufacture the inputted object.

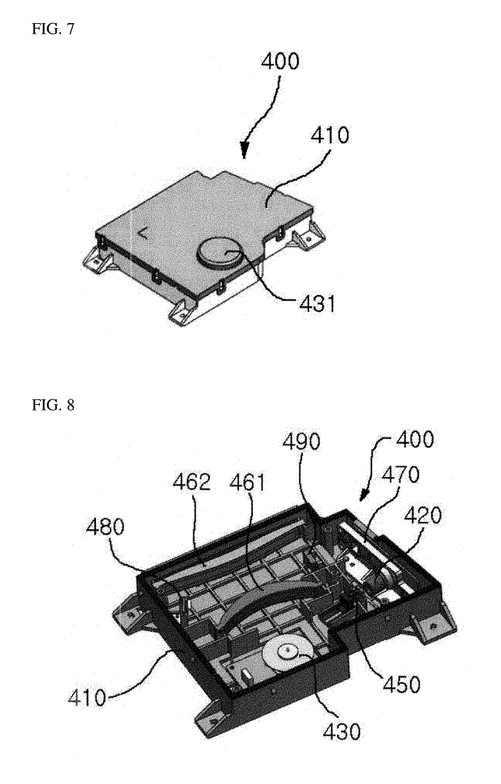

Referring to FIGS. 7 to 9, the light emission unit 400 includes a light emission unit body 410 having a predetermined internal space, a laser diode 420 disposed in the light emission unit body 410, a polygon mirror 440, and a refractive mirror 440 (see FIG. 2).

The light emission unit body 410 is fixed on the moving plate 520 of the light emission unit-carrying unit 500 and moves together with the moving plate 520 in the longitudinal direction of the vat 100.

The laser diode 420 is disposed in the light emission unit body 410 and emits a laser beam toward the polygon mirror 430. The laser diode 420 radiates UV light having a wavelength of about 380-420 nm and a power of about 580-620 mW.

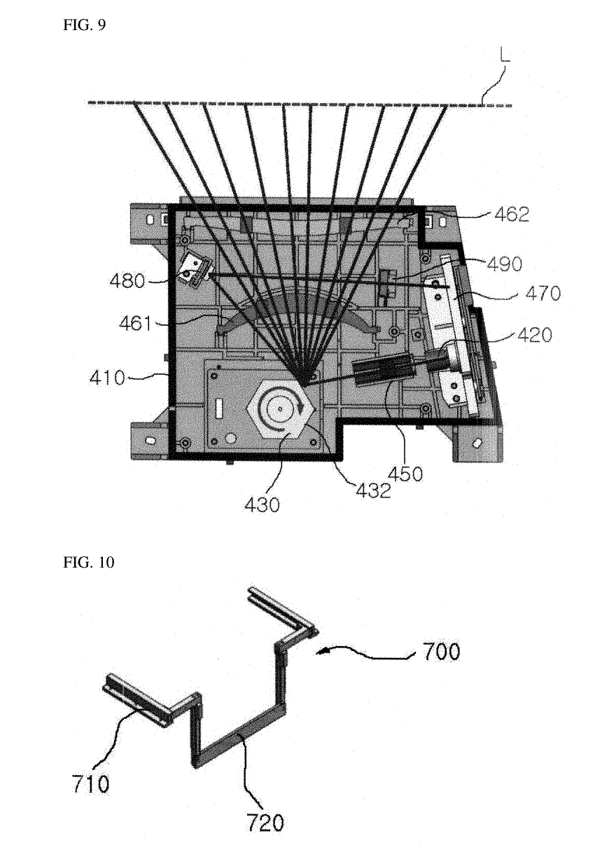

The polygon mirror 430 is disposed on the light emission unit body 410 and reflects the laser beam emitted from the laser diode 420 while being rotated by a motor 431. The polygon mirror 430 has six reflective surfaces 432 and the motor 431 rotates the polygon mirror 430 at 20,000˜43,000 rpm. The polygon mirror 430 is disposed in the light emission unit body 410 with its rotational axis perpendicular to the surface of the liquid resin in the vat 100. Accordingly, the rotational surface of the polygon mirror 430 is parallel to the surface of the liquid resin. The laser beams reflected from the polygon mirror 430 are linearly reflected in the width direction of the vat 100, as shown in FIG. 9, by rotation of the polygon mirror 430.

The refractive mirror 440, as shown in FIG. 2, is disposed between the light emission unit 400 and the vat 100 and refracts the laser beams reflected by the polygon mirror 430 to the liquid photocurable resin in the vat 100.

According to this configuration, a high-power laser beam emitted with a short wavelength from the laser diode 420 is reflected by the polygon mirror 430, whereby a linear laser beam L is formed in the width direction of the vat 100, so a laser beam can be radiated to a 2D plane by horizontal movement of the light emission unit 400. Further, it is possible to manufacture a 3D object by radiating a laser beam to the liquid resin by vertical movement of the bed 200.

Since the 3D printer using a linear laser source according to the present invention has a structure in which a laser beam emitted from the light emission unit 400 is reflected by the polygon mirror 430 having a rotational surface, which is parallel to the surface of the liquid resin in the vat 100, forms a linear laser beam and travels horizontally, it is possible to simplify the structure of the apparatus in comparison to the related art, in which a galvanometer mirror is controlled to move along X and Y axes, it is possible to enhance the precision of rotation and increase the lifespan of the polygon mirror in comparison to the related art, which uses a polygon mirror disposed at an angle to or perpendicular to the surface of liquid resin, and it is also possible to reduce the time taken to manufacture a 3D object by decreasing a laser beam emission time. Further, it is possible to simplify the control unit 600 by controlling only the light emission unit-carrying unit 500 and the bed-carrying unit 300.

Preferably, the light emission unit 400 includes lenses 450, 461, and 462 for concentrating the laser beam emitted from the laser diode 420, for example, a cylindrical lens 450, a first F-θ lens 461, and a second F-θ lens 462.

The cylindrical lens 450 is disposed between the laser diode 420 and the polygon mirror 430 and vertically concentrates a laser beam onto the reflective surfaces of the polygon mirror 430. The first F-θ lens 461 is disposed between the polygon mirror 430 and the refractive mirror 440 and concentrates laser beams reflected by the reflective surfaces of the polygon mirror 430 toward the vat. The second F-θ lens 462 is disposed between the first F-θ lens 461 and the refractive mirror 440 and concentrates the laser beams reflected by the reflective surfaces of the polygon mirror 430 toward the vat. The two lenses of the first F-θ lens 461 and the second F-θ 462 are formed in pairs, so the concentrated laser beam has a size of 00.1 mm.

Further, the light emission unit 400 further includes a beam-detecting sensor 470, a beam-detecting mirror 480, and a beam-detecting lens 490 so that the control unit 600 can determine the output start point of image data of an object.

The beam-detecting sensor 470 receives laser beams reflected from the polygon mirror 430 and sends laser reception information to the control unit 600. The beam-detecting mirror 480 reflects the laser beams reflected from the polygon mirror 430 to the beam-detecting sensor 470. The beam-detecting lens 490 is disposed between the beam-detecting mirror 480 and the beam-detecting sensor 470 and concentrates the laser beams reflected from the beam-detecting mirror 480 so that the beam-detecting sensor 470 easily receives the laser beams. The control unit 600 determines the output start point of image data of an object on the basis of the laser reception information received from the beam-detecting sensor 470. That is, the control unit 600 synchronizes resists between layers of the object.

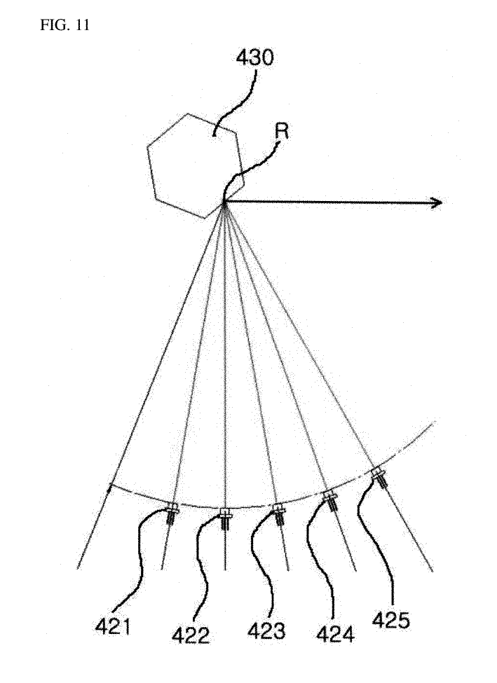

Referring to FIG. 11, the laser diode 420 may be composed of a plurality of laser diodes 421, 422, 423, 424, 425, . . . and n spaced at regular intervals from each other around any one point R on a reflective surface of the polygon mirror 430.

The laser diodes 421, 422, 423, 424, 425, . . . and n radiate laser beams such that the laser beams are concentrated onto one point on a reflective surface of the polygon mirror 430, so the power of the laser beam reflected through the reflective surface to the liquid photocurable resin in the vat 100 is increased and a curing rate is increased in proportion to this.

The 3D printer using a linear laser source according to the present invention further includes a blade unit 700 that levels the top of a 3D object that is manufactured in the vat 100, that is, the height of the manufactured surface.

Referring to FIG. 10, the blade unit 700 includes moving bars 710 coupled to the horizontal rail 510 of the light emission unit-carrying unit 500 and a blade 720 extending downward toward the vat 100. The moving bars 710 are horizontally moved together with the light emission unit 400 by the light emission unit-carrying unit 500 and the blade 720 comes in contact with the top of the object moving vertically and levels the manufactured surface. As described above, since the blade unit 700 can be moved along with the light emission unit 400 by the light emission unit-carrying unit 500, the configuration and control of the apparatus is simple.

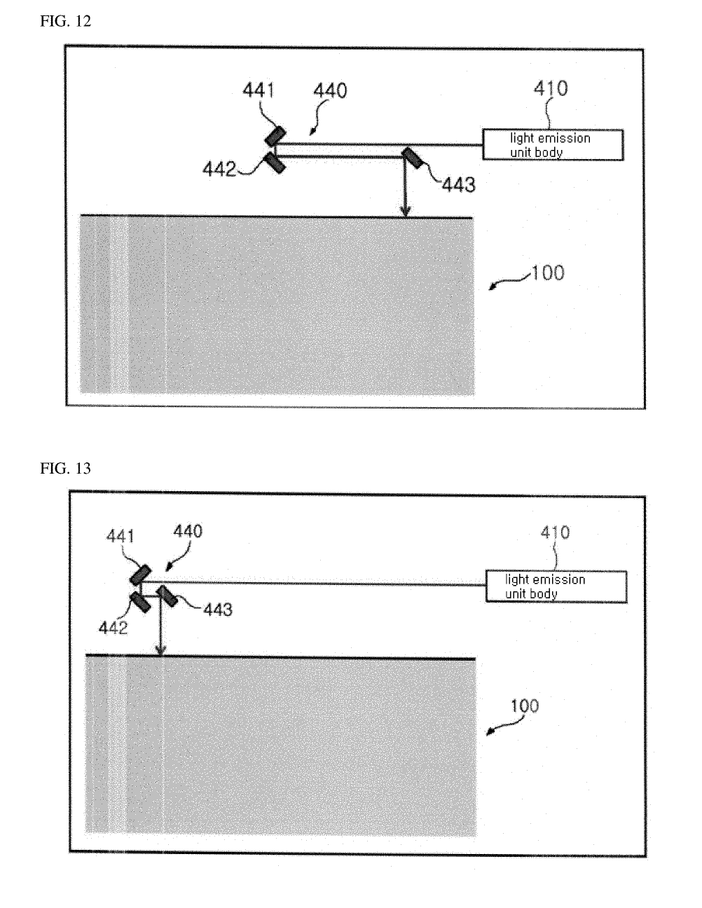

Alternatively, referring to FIGS. 12 and 13, the 3D printer using a linear laser source according to the present invention may linearly radiate a laser beam in the width direction of the vat 100 with the light emission unit body 410 fixed to the frame 10.

In this alternative embodiment, since the light emission unit body 410 is fixed to the frame 10, it cannot move. Further, the refractive mirror 440 is disposed between the light emission unit body 410 and the vat 100 so as to be movable parallel to the surface of the liquid resin in the vat 100.

According to the alternative embodiment of the present invention, as described above, since the light emission unit body 410 is fixed and only the refractive mirror 440 can be moved, the refractive mirror 440 can be moved at a high speed over the vat 100. Further, since the refractive mirror 440 is lighter than the light emission unit body 410, the refractive mirror 440 is less influenced by inertia and vibration, which is advantageous in terms of light emission quality.

Preferably, the refractive mirror 440 may be composed of three mirrors 441, 442, and 443 so as to maintain a constant length of the path of the laser that is radiated from the laser diode 420 to the liquid resin in the vat 100 through the refractive mirror 440.

In detail, the refractive mirror 440 includes: a first mirror 441 that vertically refracts downwards a laser beam horizontally emitted from the laser diode 420 toward the vat 100; a second mirror 442 that is disposed under the first mirror 441 and horizontally refracts the laser beam refracted by the first mirror 441 toward the light emission unit body 410; and a third mirror 443 that is disposed at the same height as the second mirror 442 and refracts downward the laser beam refracted by the second mirror 442 to radiate the laser beam to the liquid resin in the vat 100.

The first mirror 441 and the second mirror 442 are moved together, that is, at the same speed, and the third mirror 443 is moved at a different speed from the first and second mirrors 441 and 442. The movement speed of the first and second mirrors 441 and 442 and the movement speed of the third mirror 443 are controlled so as to maintain a constant length of the path of the laser beam emitted from the laser diode 420 to the liquid resin through the three mirrors 441, 442, and 443. Accordingly, the focus of the laser beam emitted to the liquid resin is maintained constant, so it is possible to prevent the performance of curing the liquid resin from being deteriorated.

What is claimed is:

1. A 3D printer using a linear laser source, the 3D printer comprising:
a vat disposed at a lower portion inside a frame and configured to contain liquid photocurable resin therein;
a bed configured to be vertically movable in the vat and to support an object;
a bed-carrying unit configured to move the bed vertically;
a light emission unit configured to cure the liquid photocurable resin in the vat to form the object by radiating a laser beam to the liquid photocurable resin in the vat;
a light emission unit-carrying unit configured to move the light emission unit in a longitudinal direction of the vat; and
a control unit configured to control operation of the light emission unit, the light emission unit-carrying unit, and the bed-carrying unit,
wherein the light emission unit is configured to linearly radiate a laser beam in a width direction of the vat and includes:
a light emission unit body fixed to the light emission unit-carrying unit to be moved in the longitudinal direction of the vat;
a laser diode disposed in the light emission unit body and configured to radiate a laser beam in a predetermined direction;
a polygon mirror disposed in the light emission unit body and configured to linearly reflect the laser beam emitted from the laser diode in a width direction of the vat while rotating; and
a refractive mirror disposed between the light emission unit body and the vat and configured to refract the laser beam reflected from the polygon mirror to the liquid photocurable resin in the vat, and
the laser diode is composed of a plurality of laser diodes spaced at regular intervals from each other around a point on the polygon mirror and the plurality of laser diodes radiates laser beams such that the laser beams are concentrated onto the point on the polygon mirror.

2. The 3D printer of claim 1, wherein the polygon mirror has a rotational axis perpendicular to a surface of the liquid photocurable resin in the vat and has a rotational surface parallel to the surface of the liquid photocurable resin.

3. The 3D printer of claim 1, wherein the light emission unit further includes:
a cylindrical lens configured to concentrate the laser beam emitted from the laser diode to reflective surfaces of the polygon mirror;
a first F-θ lens disposed between the polygon mirror and the refractive mirror and configured to concentrate laser beams reflected by the reflective surfaces of the polygon mirror toward the vat; and
a second F-θ lens disposed between the first F-θ lens and the refractive mirror and configured to concentrate the laser beams reflected by the reflective surfaces of the polygon mirror toward the vat.

4. The 3D printer of claim 1, wherein the light emission unit further includes:
a beam-detecting sensor configured to determine an output start point of image data of the object by receiving the laser beams reflected from the polygon mirror;
a beam-detecting mirror configured to reflect the laser beams reflected from the polygon mirror to the beam-detecting sensor; and
a beam-detecting lens disposed between the beam-detecting mirror and the beam-detecting sensor and configured to concentrate the laser beams reflected from the beam-detecting mirror.

5. The 3D printer of claim 1, further comprising a blade unit configured to level a top of the object that is manufactured in the vat by horizontally moving in the longitudinal direction of the vat and to be moved along with the light emission unit by the light emission unit-carrying unit.

6. A 3D printer using a linear laser source, the 3D printer comprising:
a vat disposed at a lower portion inside a frame and configured to contain liquid photocurable resin therein;
a bed configured to be vertically movable in the vat and to support an object;
a bed-carrying unit configured to move the bed vertically;
a light emission unit configured to cure the liquid photocurable resin in the vat to form the object by radiating a laser beam to the liquid photocurable resin in the vat; and
a control unit configured to control operation of the light emission unit and the bed-carrying unit,
wherein the light emission unit is configured to linearly radiate a laser beam in a width direction of the vat and includes:
a light emission unit body fixed to the frame;
a laser diode disposed in the light emission unit body and configured to radiate a laser beam in a predetermined direction;
a polygon mirror disposed in the light emission unit body and configured to linearly reflect the laser beam emitted from the laser diode in the width direction of the vat while rotating; and
a refractive mirror disposed between the light emission unit body and the vat to be movable parallel to the surface of the liquid photocurable resin in the vat and configured to refract the laser beam reflected from the polygon mirror to the liquid photocurable resin in the vat, and
the laser diode is composed of a plurality of laser diodes spaced at regular intervals from each other around a point on the polygon mirror and the plurality of laser diodes radiates laser beams such that the laser beams are concentrated onto the point on the polygon mirror.

7. The 3D printer of claim 6, wherein the refractive mirror includes:
a first mirror configured to refract vertically downwards a laser beam emitted horizontally from the laser diode;
a second mirror disposed under the first mirror and configured to horizontally refract the laser beam refracted by the first mirror toward the light emission unit body; and
a third mirror disposed at the same height as the second mirror and configured to refract vertically downwards the laser beam refracted by the second mirror to the liquid photocurable resin in the vat.

8. The 3D printer of claim 7, wherein the first mirror and the second mirror can be moved together, and the third mirror is moved at a different speed from the first mirror and the second mirror to maintain a constant length of the path of a laser beam from the laser diode to the liquid photocurable resin.
